(19) United States
(12) Patent Application Publication
(10) Pub. No.: US 2016/0147716 A1
(43) Pub. Date: May 26, 2016

(54) SCREEN DISPLAY PROGRAM

(71) Applicant: NOMURA RESEARCH INSTITUTE, LTD., Tokyo (JP)

(72) Inventors: Hitoshi YANO, Tokyo (JP); Koji NAKAJIMA, Tokyo (JP); Koji TERADA, Tokyo (JP)

(73) Assignee: NOMURA RESEARCH INSTITUTE, LTD., Tokyo (JP)

(21) Appl. No.: 15/013,353

(22) Filed: Feb. 2, 2016

Related U.S. Application Data
(63) Continuation of application No. PCT/JP2013/071150, filed on Aug. 5, 2013.

(51) Int. Cl. G06F 17/21; G06F 17/30; G06F 3/0484; H04W 88/02; G06F 3/0481

(52) U.S. Cl. CPC G06F 17/212; H04W 88/02; G06F 3/0481; G06F 3/04847; G06F 17/30905; G06F 17/30902

(57) ABSTRACT

A screen display program causes a mobile terminal configured to be communicably connected to a server to execute an update screen display procedure that includes displaying an update screen for updating data on the server, an update request transmission procedure that includes transmitting a data update request to the server in response to an update instruction for data that is input on the update screen, and a screen transition prohibiting procedure that includes prohibiting a transition from the update screen to another screen during a period of time from when the update instruction is input until completion of data updating on the server.

### CROSS-REFERENCE TO RELATED APPLICATIONS

This application is a continuation application, filed under 35 U.S.C. §111(a), of International Application PCT/JP2013/071150 filed on Aug. 5, 2013, the disclosure of which is incorporated herein by reference.

### BACKGROUND

The popularization of mobile terminals, such as smartphones, increases opportunities to use a variety of services such as an Internet banking system from mobile terminals (e.g., JP 2012-247927 A). In such an Internet banking system, for example, a variety of services such as transfer and balance inquiry are provided.

FIG. 9 is a diagram illustrating an example of a screen for making a transfer in an Internet banking system. In FIG. 9, a transfer content entered by a user, such as a transfer account and a transfer amount, is displayed. The user checks the content displayed on the screen of FIG. 9, and selects an “OK” button 900 displayed in the lower part of the screen of FIG. 9. Thus, the transfer with the content entered by the user is made.

In the meantime, a “menu” button 910 for selecting one of a variety of services in the Internet banking system is displayed in the upper part of the screen illustrated in FIG. 9. Therefore, even during using the transfer service, the user can select the “menu” button 910 to use any other service at any time.

However, if any other service is made available at any time during using the transfer service, there is a possibility that the other service is used before completion of updating of data, such as an account balance in the transfer processing to cause inconsistent data.

### SUMMARY

Various embodiments described herein have been made in view of the circumstances discussed above, and it is an object thereof to prevent data from being inconsistent in using a service with data updating.

A screen display program according to various embodiments described herein causes a mobile terminal that is configured to be communicably connected to a server to execute an update screen display procedure that includes displaying an update screen for updating data on the server, an update request transmission procedure that includes transmitting a data update request to the server in response to an update instruction for data that is input on the update screen, and a screen transition prohibiting procedure that includes prohibiting a transition from the update screen to another screen during a period of time from when the update instruction is input until completion of data updating on the server.

A method according to various embodiments described herein is performed in a mobile terminal with a touch screen display that is configured to be communicably connected to a server and includes displaying an update screen for updating data on the server, transmitting a data update request to the server in response to an update instruction for data that is input on the update screen, and prohibiting a transition from the update screen to another screen during a period of time from when the update instruction is input until completion of data updating on the server.

According to various embodiments described herein, the term “block” does not merely relate to a physical device, but also includes a case where the function of the “block” is implemented by software. Further, the function of one “block” or device may be implemented by two or more physical devices, or the functions of two or more “blocks” or devices may be implemented by one physical device.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram of the configuration of an information processing system according to an embodiment;

FIG. 2 is a diagram of the hardware configuration of a mobile terminal;

FIG. 3 is a diagram of functional blocks in the mobile terminal;

FIG. 4 is a diagram of the hardware configuration of an Internet banking system;

FIG. 5 is a diagram of functional blocks in the Internet banking system;

FIG. 6 is a diagram of a menu screen displayed on the mobile terminal;

FIG. 7A is a diagram of a screen for inputting transfer conditions;

FIG. 7B is a diagram of a screen displayed during updating of data associated with the transfer;

FIG. 7C is a diagram of a screen displayed after completion of updating of the data associated with the transfer;

FIG. 8A is a diagram of a screen for inputting conditions for an account activity inquiry;

FIG. 8B is a diagram of a screen displayed during the account activity inquiry;

FIG. 8C is a diagram of a screen illustrating the results of the account activity inquiry; and

FIG. 9 is a diagram of a screen for inputting transfer conditions.

### DETAILED DESCRIPTION

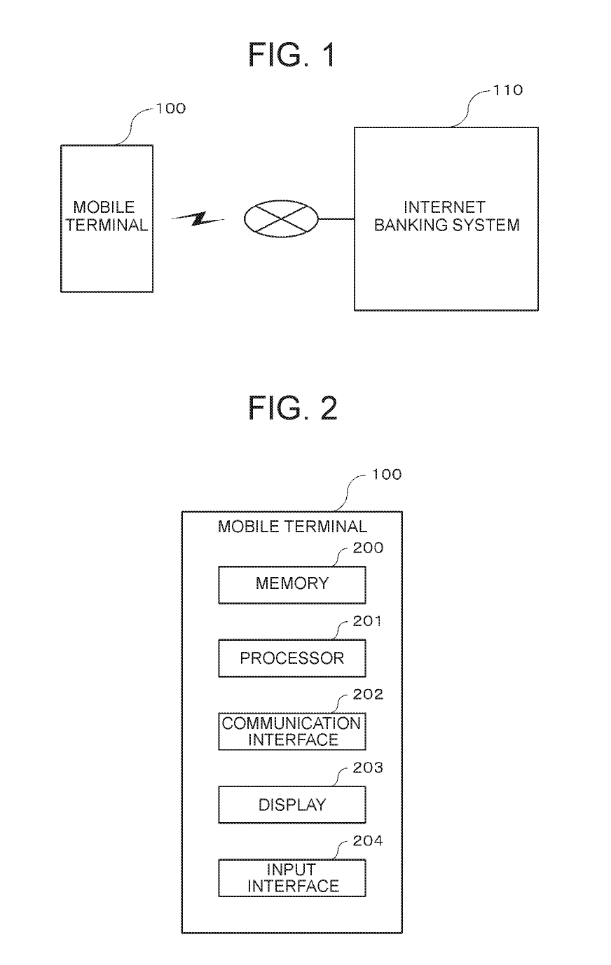

FIG. 1 is a diagram illustrating the configuration of an information processing system according to an embodiment. The information processing system includes a mobile terminal 100 and an Internet banking system 110.

The mobile terminal 100 is, for example, a portable computer, such as a smartphone or a tablet terminal. For example, the mobile terminal 100 can access the Internet through a radio communication network for cellular phones or a wireless LAN (Local Area Network). In the embodiment, the mobile terminal 100 can access the Internet banking system 110. Although only one mobile terminal 100 is illustrated in FIG. 1, there exist many mobile terminals 100 that use the Internet banking system 110.

The Internet banking system 110 is a system for providing various financial services via the Internet, such as balance inquiry and transfer. For example, the Internet banking system 110 includes one or more computers. The Internet banking system 110 can also provide services to the mobile terminal 100 in cooperation with other systems, such as a billing system and a database system.

FIG. 2 is a diagram illustrating an example of the hardware configuration of the mobile terminal 100. As illustrated in FIG. 2, the mobile terminal 100 includes a memory 200, a processor 201, a communication interface 202, a display 203, and an input interface 204.

The memory 200 is a storage area for storing data and programs. The data and programs may be stored in the memory 200 permanently or temporarily. For example, a web browser program as an application used to access the Internet banking system 110 is stored in the memory 200. Further, HTML (HyperText Markup Language) files, style sheets, and the like, used by a web browser to provide a screen display during accessing the Internet banking system 110 using the web browser, are stored in the memory 200. The HTML files and the like used by application programs are also programs for controlling the operation of the mobile terminal 100.

The processor 201 executes programs stored in the memory 200 to implement various functions of the mobile terminal 100. For example, the processor 201 executes the web browser program stored in the memory 200 to implement various functions for using the Internet banking system 110.

The communication interface 202 is an interface for exchanging data with the outside of the mobile terminal 100. For example, the communication interface 202 includes an interface for accessing the radio communication network for cellular phones, an interface for accessing the wireless LAN, and the like. For example, the communication interface 202 may also include an interface for a wired network, such as USB (Universal Serial Bus).

The display 203 is a device for displaying a variety of information, which is, for example, a liquid crystal display or an organic EL (Electroluminescence) display.

The input interface 204 is a device for accepting input from a user. For example, the input interface 204 includes a touch panel provided on the display 203, various input keys, and the like.

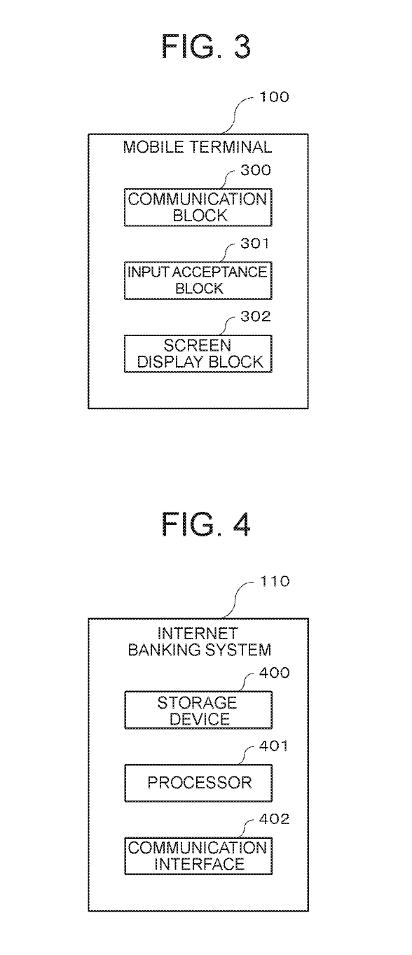

FIG. 3 is a diagram illustrating an example of functional blocks in the mobile terminal 100. The functions illustrated in FIG. 3 are some functions used to use the Internet banking system 110, and not all the functions of the mobile terminal 100. As illustrated in FIG. 3, the mobile terminal 100 includes a communication block 300, an input acceptance block 301, and a screen display block 302. For example, each of these blocks is implemented by the processor 201 executing a program stored in the memory 200.

The communication block 300 exchanges data and programs with the Internet banking system 110. For example, the communication block 300 transmits an acquisition request for data and programs to the Internet banking system 110 so that an HTML file, an XML (Extensible Markup Language) file, a style sheet, image data, and the like can be received from the Internet banking system 110 according to the acquisition request. The data and programs received from the Internet banking system 110 are stored in the memory 200.

The input acceptance block 301 accepts various pieces of user input when the user uses the Internet banking system 110. For example, the input acceptance block 301 can accept input of a user ID and a password, and input for specifying a transfer account.

The screen display block 302 displays, on the display 203, various screens for using the Internet banking system 110 based on the HTML file and the like received from the Internet banking system 110.

FIG. 4 is a diagram illustrating an example of the hardware configuration of the Internet banking system 110. As illustrated in FIG. 4, the Internet banking system 110 includes a storage device 400, a processor 401, and a communication interface 402.

The storage device 400 is a storage area such as a memory or a hard disk drive. Data and programs for implementing the Internet banking system 110 are stored in the storage device 400. For example, programs for implementing various functions of the Internet banking system 110, HTML files for displaying screens on the mobile terminal 100 to use the Internet banking system 110, account data for user authentication, various types of data necessary to perform bank transactions, and the like are stored in the storage device 400.

There is no need to pre-store, in the storage device 400, all pieces of data and programs used in the Internet banking system 110. Some pieces of data and programs may be acquired from outside through the communication interface 402 as needed and stored in the storage device 400.

The processor 401 executes programs stored in the storage device 400 to implement various functions in the Internet banking system 110.

The communication interface 402 is an interface for exchanging data with the outside of the Internet banking system 110. For example, the communication interface 402 can include an interface such as Ethernet (registered trademark).

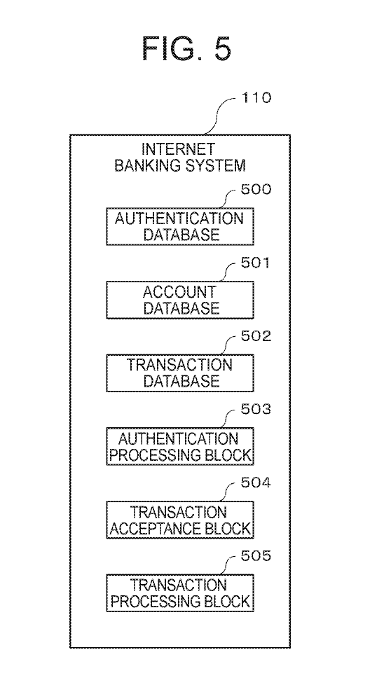

FIG. 5 is a diagram illustrating an example of functional blocks in the Internet banking system 110. As illustrated in FIG. 5, the Internet banking system 110 includes an authentication database 500, an account database 501, a transaction database 502, an authentication processing block 503, a transaction acceptance block 504, and a transaction processing block 505. Each of these blocks is, for example, implemented by the processor 401 executing a program stored in the storage device 400.

The authentication database 500 stores account data, such as a user ID, a password, PIN, and the like used to use the Internet banking system 110.

The account database 501 stores account data indicative of information on each account, such as account number, account holder, and account balance.

The transaction database 502 stores transaction data necessary to conduct a transaction requested from a user in the Internet banking system 110. For example, in the case of a transfer, transaction data indicative of the settlement account, the transfer account, the transfer amount, and the like are stored in the transaction database 502.

The authentication processing block 503 performs authentication processing based on the account data stored in the authentication database 500. The authentication processing is performed, for example, at the time of logging in to the Internet banking system 110, at the time of executing a transfer process, and the like.

The transaction acceptance block 504 accepts a transaction request from the user. Transactions accepted by the transaction acceptance block 504 include inquiry transactions without data updating and update transactions with data updating. For example, the inquiry transactions include a balance inquiry and an account activity inquiry. Further, for example, the update transactions include wire transfer and account transfer. When accepting a request for an update transaction, the transaction acceptance block 504 stores, in the transaction database 502, transaction data necessary to conduct the transaction.

Based on the transaction data stored in the transaction database 502, the transaction processing block 505 conducts the transaction requested from the user. For example, based on the transaction data, the transaction processing block 505 updates the account database 501, or generates data to be output to another system. The other system is, for example, a batch processing system in the same bank, a system of another bank connected through an interbank network, or the like.

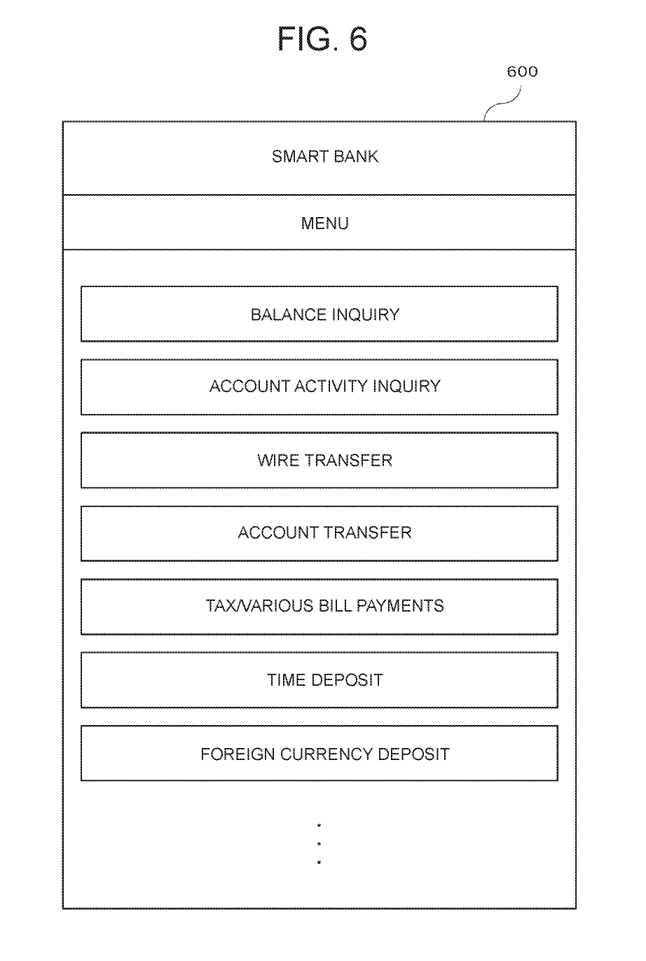

Next, an example of screen control in the Internet banking system 110 will be described. FIG. 6 is a diagram illustrating an example of a menu screen displayed on the mobile terminal 100. A menu screen 600 is displayed, for example, after logging in to the Internet banking system 110. Specifically, the input acceptance block 301 of the mobile terminal 100 accepts a user ID and a password for logging in to the Internet banking system 110, and transmits them to the Internet banking system 110. The authentication processing block 503 of the Internet banking system 110 performs authentication processing based on the accepted user ID and password. When the authentication is done correctly, the transaction acceptance block 504 transmits, to the mobile terminal 100, an HTML file and the like for displaying the menu screen 600. Based on the HTML file and the like received from the Internet banking system 110, the screen display block 302 of the mobile terminal 100 displays the menu screen 600 on the display 203 of the mobile terminal 100. Thus, on the menu screen 600, the input acceptance block 301 can accept input for selecting a transaction.

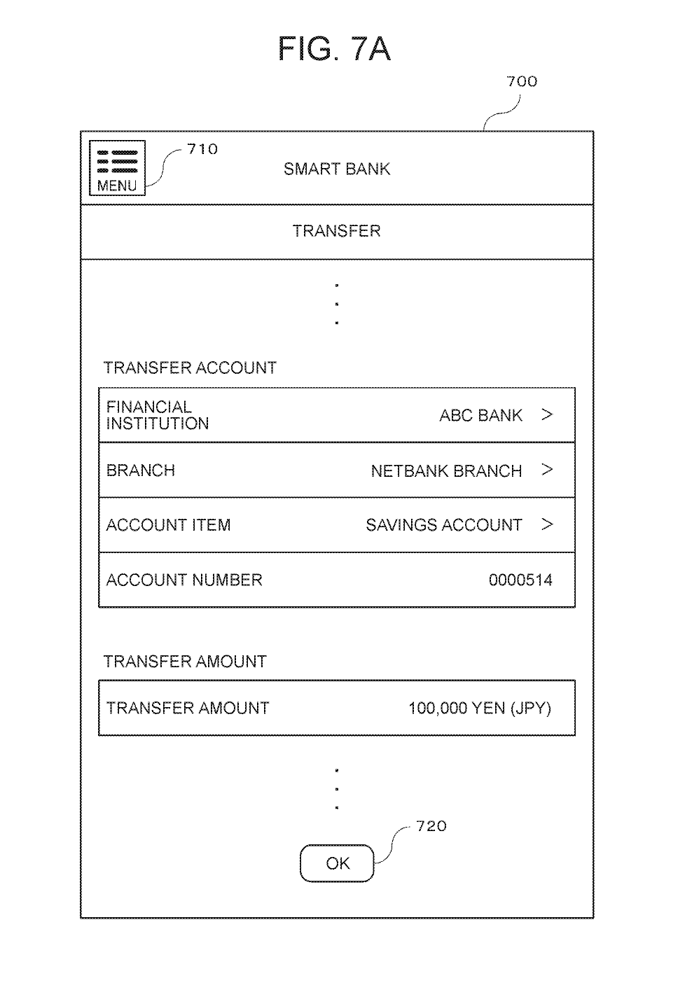

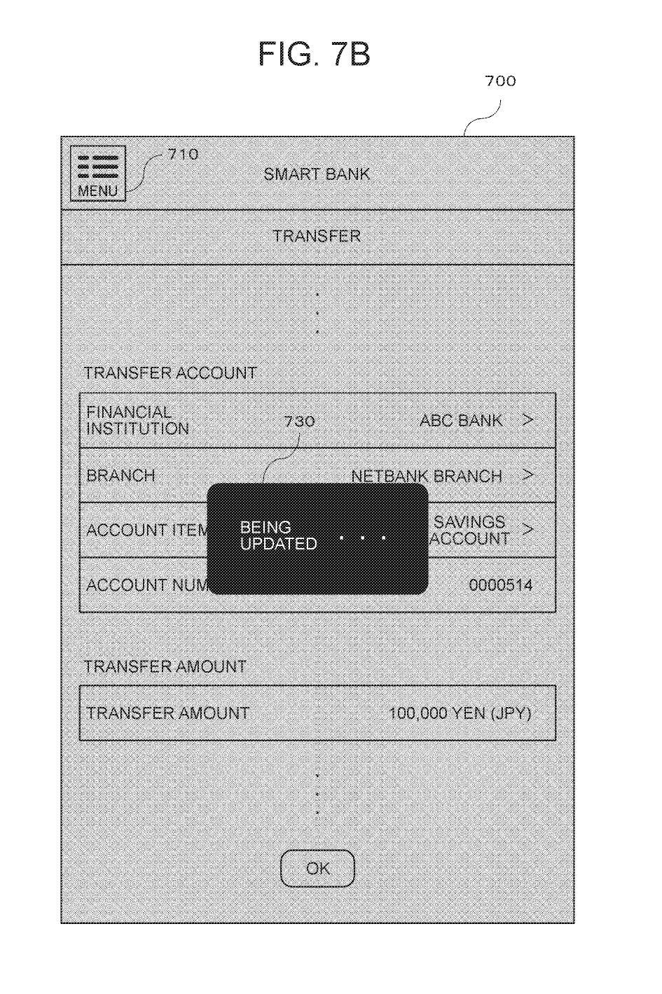

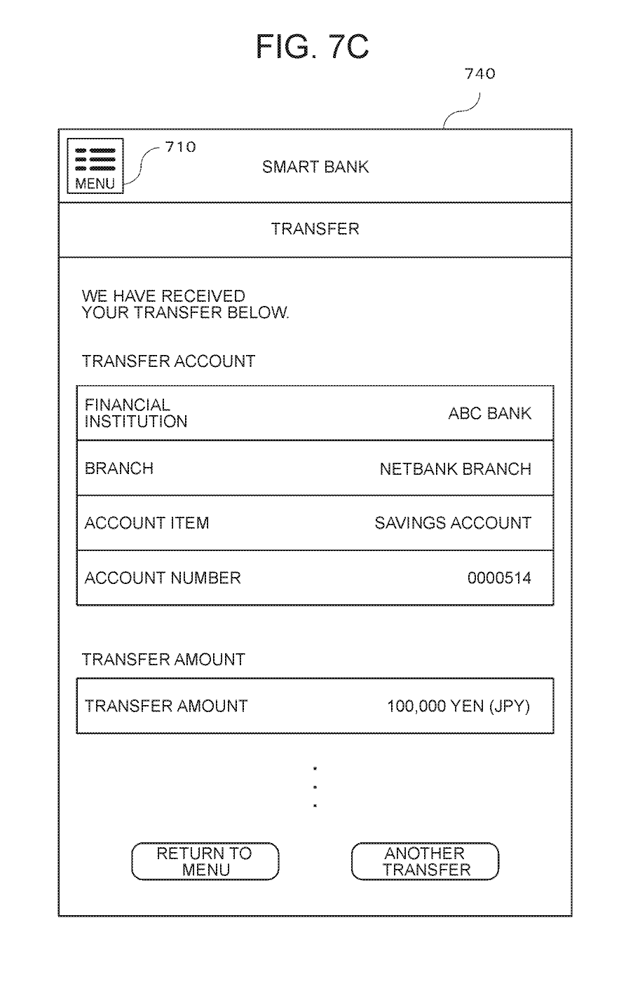

FIGS. 7A through 7C are diagrams illustrating an example of transfer screens displayed on the mobile terminal 100. A transfer screen 700 (update screen) illustrated in FIG. 7A is, for example, displayed by selecting “transfer” on the menu screen 600 illustrated in FIG. 6. Specifically, when accepting the selection of “transfer” on the menu screen 600, the input acceptance block 301 of the mobile terminal 100 transmits a screen output request for making a transfer to the Internet banking system 110. In response to the request, the transaction acceptance block 504 of the Internet banking system 110 transmits, to the mobile terminal 100, an HTML file and the like for displaying the transfer screen 700. Based on the HTML file and the like received from the Internet banking system 110, the screen display block 302 of the mobile terminal 100 displays the transfer screen 700 on the display 203 of the mobile terminal 100 (update screen display procedure).

A “menu” button 710 is contained in the transfer screen 700. When the “menu” button 710 is selected on the transfer screen 700, the screen display block 302 can display the menu screen 600 illustrated in FIG. 6.

On the transfer screen 700 illustrated in FIG. 7A, the input acceptance block 301 accepts input, such as a transfer account and a transfer amount. When an “OK” button 720 is selected on the transfer screen 700 (update instruction), the input acceptance block 301 transmits, to the Internet banking system 110, a transaction request (update request) including information such as the input transfer account (update request transmission procedure). Based on the transaction request, the transaction acceptance block 504 of the Internet banking system 110 stores transaction data in the transaction database 502. Then, the transaction processing block 505 updates the account database 501 based on the transaction data.

Here, during a period from when the “OK” button is selected on the transfer screen 700 illustrated in FIG. 7A until completion of data updating in the Internet banking system 110 (for example, updating of the transaction database 502 and the account database 501), the screen display block 302 makes the entire transfer screen 700 inoperable (locks the entire screen) while displaying a message 730 (update message) indicative of being updated (update message display procedure), as illustrated in FIG. 7B. In other words, the screen display block 302 prohibits a transition from the transfer screen 700 to another screen. Since a transition to another screen is made by selecting the “menu” button 710, the screen display block 302 can make the “menu” button 710 unselectable to prohibit the screen transition (screen transition prohibiting procedure).

When receiving, from the Internet banking system 110, a notification that data updating is completed, the screen display block 302 releases the lock on the transfer screen 700. For example, when receiving, from the Internet banking system 110, an HTML file and the like indicative of the results of transfer processing, the screen display block 302 can display a screen 740 indicative of the results of the transfer processing as illustrated in FIG. 7C. On this screen 740, the “menu” button 710 is selectable.

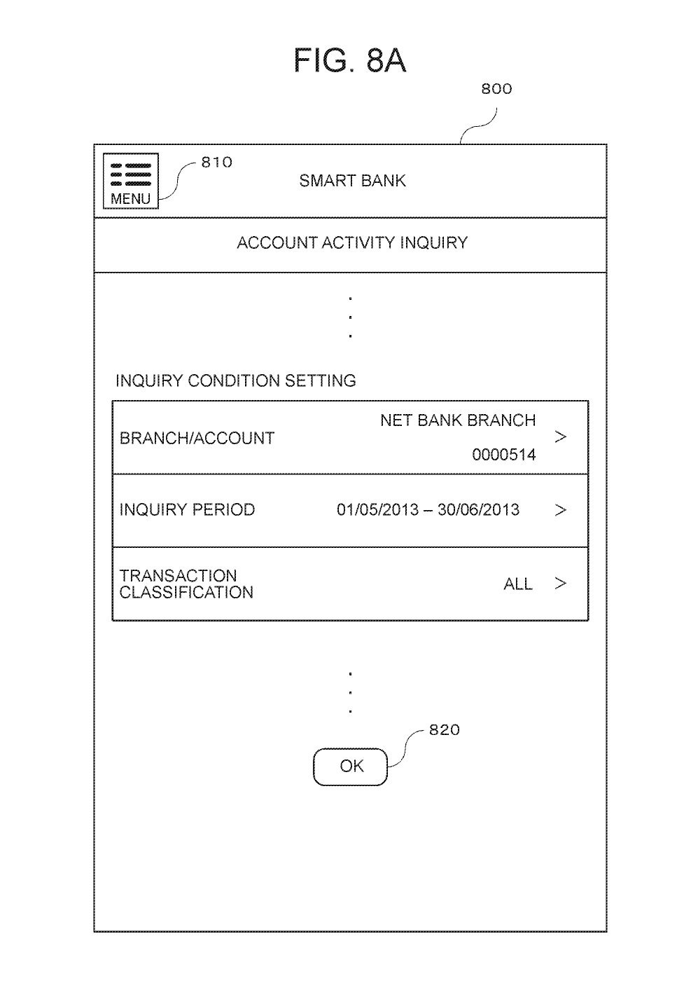

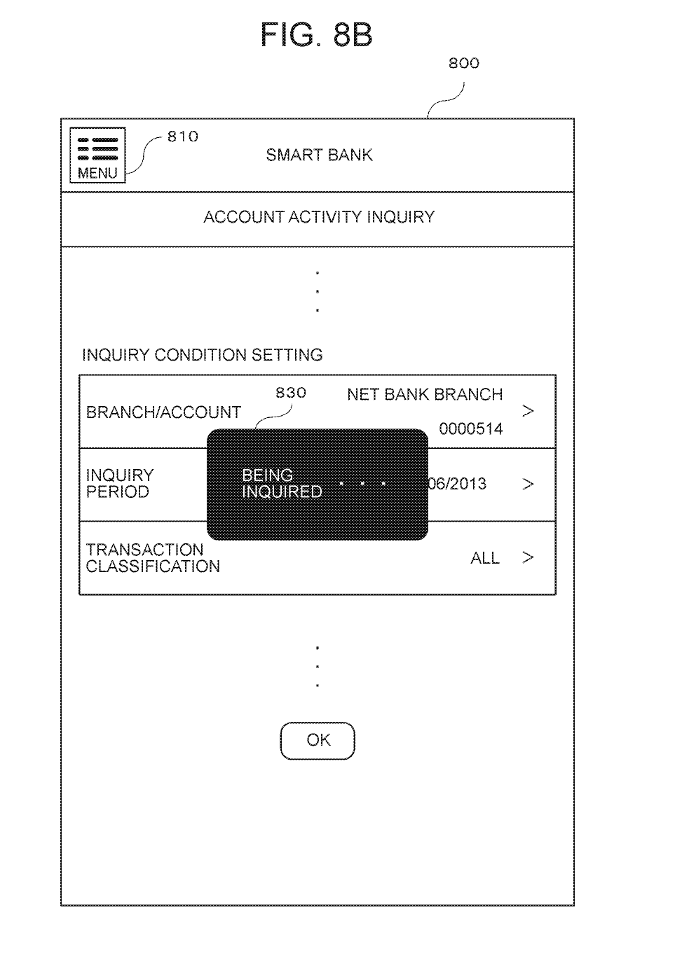

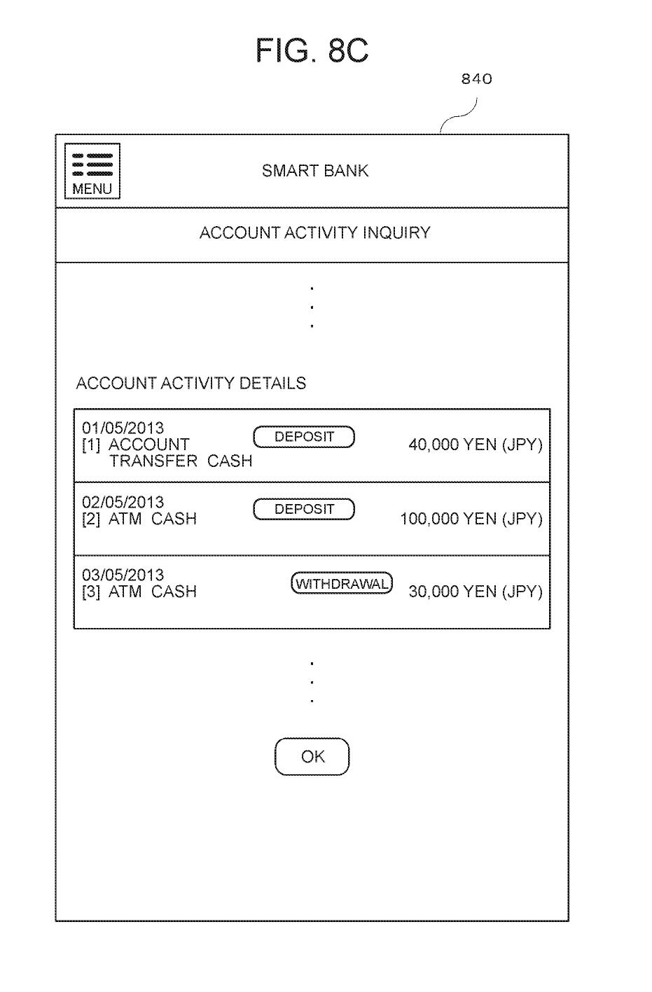

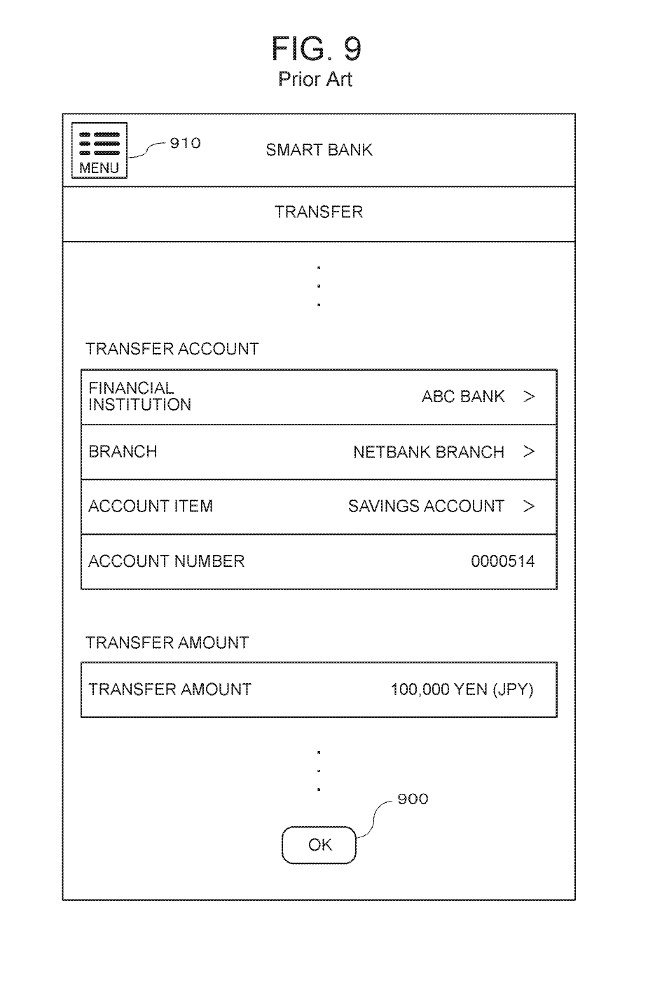

FIG. 8A through FIG. 8C are diagrams illustrating an example of an account activity inquiry screen (hereinafter called an “inquiry screen”) displayed on the mobile terminal 100. An inquiry screen 800 illustrated in FIG. 8A is displayed, for example, by selecting an “account activity inquiry” on the menu screen 600 illustrated in FIG. 6. Specifically, when accepting the selection of the “account activity inquiry” on the menu screen 600, the input acceptance block 301 of the mobile terminal 100 transmits, to the Internet banking system 110, a screen output request for making an account activity inquiry. In response to the request, the transaction acceptance block 504 of the Internet banking system 110 transmits, to the mobile terminal 100, an HTML file and the like for displaying the inquiry screen 800. Based on the HTML file and the like received from the Internet banking system 110, the screen display block 302 of the mobile terminal 100 displays the inquiry screen 800 on the display 203 of the mobile terminal 100 (inquiry screen display procedure).

The inquiry screen 800 contains a “menu” button 810. When the “menu” button 810 is selected on the inquiry screen 800, the screen display block 302 can display the menu screen 600 illustrated in FIG. 6.

On the inquiry screen 800 illustrated in FIG. 8A, the input acceptance block 301 accepts account activity inquiry conditions such as a branch, an account number, and an inquiry period. When an “OK” button 820 is selected on the inquiry screen 800 (inquiry instruction), the input acceptance block 301 transmits, to the Internet banking system 110, a transaction request (inquiry request) including the input inquiry conditions (inquiry request transmission procedure). Based on the transaction request, the transaction acceptance block 504 of the Internet banking system 110 refers to the account database 501 and the transaction database 502 to search for account activity details.

Here, during a period from when the “OK” button is selected on the inquiry screen 800 illustrated in FIG. 8A until completion of searching for the account activity details in the Internet banking system 110, the screen display block 302 displays a message 830 (inquiry message) as illustrated in FIG. 8B to indicate that the account activity details are being inquired (inquiry message display procedure). At this time, the screen display block 302 keeps the “menu” button 810 selectable, unlike the case of the transfer screen 700. In other words, the screen display block 302 can accept input for a transition from the inquiry screen 800 to another screen (screen transition input accepting procedure).

When receiving, from the Internet banking system 110, an HTML file and the like indicative of the account activity inquiry results, the screen display block 302 can display a screen 840 indicative of the account activity inquiry results as illustrated in FIG. 8C.

According to this embodiment, the entire transfer screen 700 is locked during data updating in the transfer processing to prohibit a transition to another screen. In this embodiment, transfer is described as a service with data updating, but the same screen control can be performed on other services with data updating, such as wire transfer and account transfer. This can prevent data from being inconsistent in using a service with data updating. Note that “data” to be updated is data likely to be inconsistent in a transaction due to updating of any other piece of data during updating of the data. Therefore, for example, data unlikely to be inconsistent in the transaction, such as log information on user's operations, are not included in the “data” to be updated.

Further, according to this embodiment, the message 730 indicating that data is being updated can be displayed as illustrated in FIG. 7B, while the screen is being locked due to data updating. This can notify the user that the reason why the screen is locked is because data is being updated.

Further, according to this embodiment, the message 830 indicating that data is being inquired can be displayed as illustrated in FIG. 8B while data is being inquired. This can notify the user that data is being inquired.

Further, according to this embodiment, input for a transition to another screen can be accepted during data inquiry. Since there is no possibility of inconsistent data during data inquiry, even if a transition to another screen is made, the transition to another screen is enabled to improve user operability.

The described embodiment is to facilitate the understanding of the present invention, and is not to limit the interpretation of the present invention. The present invention can be modified and improved without departing from the spirit of the invention, and equivalents thereof are included in the present invention.

In the various embodiments, the transfer screen 700 or the account activity screen 800 in the Internet banking system 110 has been described as an example, but the target screen is not limited thereto. For example, it may be any other screen in the Internet banking system 110, or may be a screen in an entirely different system.

In various embodiments according to the present disclosure, including those discussed above, functionalities of the blocks may be implemented in the form of at least one hardware processor configured to carry out these functionalities. That is, the performance of any one or more of the functionalities may be accomplished by a single hardware processor, or be divided, in any manner known to those skilled in the art, among multiple hardware processors.

The various embodiments have been described in detail with particular reference and examples, but it will be understood that variations and modifications can be effected within the spirit and scope of the various embodiments covered by the claims which may include the phrase “at least one of A, B and C” as an alternative expression that means one or more of A, B and C may be used, contrary to the holding in Superguide V. DIRECTV, 69 USPQ2d 1865 (Fed. Cir. 2004).

What is claimed is:

1. A non-transitory computer-readable storage medium storing a screen display program for causing a mobile terminal that is configured to be communicably connected to a server to execute:
an update screen display procedure that includes displaying an update screen for updating data on the server;
an update request transmission procedure that includes transmitting a data update request to the server in response to an update instruction for data that is input on the update screen; and
a screen transition prohibiting procedure that includes prohibiting a transition from the update screen to another screen during a period of time from when the update instruction is input until completion of data updating on the server.

2. The non-transitory computer-readable storage medium according to claim 1, wherein the screen transition prohibiting procedure includes displaying, on the update screen, a message indicating that data is being updated, during the period of time from when the update instruction is input until the completion of data updating on the server.

3. The non-transitory computer-readable storage medium according to claim 2, causing the mobile terminal to further execute:
an inquiry screen display procedure that includes displaying an inquiry screen for inquiring data on the server;
an inquiry request transmission procedure that includes transmitting a data inquiry request to the server in response to an inquiry instruction for inquiry data to be input on the inquiry screen; and
an inquiry message display procedure that includes displaying, on the inquiry screen, an inquiry message indicating that data is being inquired, during a period of time from when the inquiry instruction is input until the inquiry data is received from the server.

4. The storage medium according to claim 3, causing the mobile terminal to further execute a screen transition input accepting procedure that includes accepting an input for a transition to another screen while the inquiry message is being displayed.

5. The non-transitory computer-readable storage medium according to claim 1, causing the mobile terminal to further execute:
an inquiry screen display procedure that includes displaying an inquiry screen for inquiring data on the server;
an inquiry request transmission procedure that includes transmitting a data inquiry request to the server in response to an inquiry instruction for inquiry data that is input on the inquiry screen; and
an inquiry message display procedure that includes displaying, on the inquiry screen, an inquiry message indicating that data is being inquired, during a period of time from when the inquiry instruction is input until the inquiry data is received from the server.

6. The storage medium according to claim 5, causing the mobile terminal to further execute a screen transition input accepting procedure that includes accepting an input for a transition to another screen while the inquiry message is being displayed.

7. A method, comprising:
in a mobile terminal with a touch screen display that is configured to be communicably connected to a server,
displaying an update screen for updating data on the server;
transmitting a data update request to the server in response to an update instruction for data that is input on the update screen; and
prohibiting a transition from the update screen to another screen during a period of time from when the update instruction is input until completion of data updating on the server.

8. The method according to claim 7, further comprising, in the mobile terminal, displaying, on the update screen, a message indicating that data is being updated, during the period of time from when the update instruction is input until the completion of data updating on the server.

9. The method according to claim 8, further comprising, in the mobile terminal,
displaying an inquiry screen for inquiring data on the server;
transmitting a data inquiry request to the server in response to an inquiry instruction for inquiry data to be input on the inquiry screen; and
displaying, on the inquiry screen, an inquiry message indicating that data is being inquired, during a period of time from when the inquiry instruction is input until the inquiry data is received from the server.

10. The method according to claim 9, further comprising, in the mobile terminal, accepting an input for a transition to another screen while the inquiry message is being displayed.

11. The method according to claim 7, further comprising, in the mobile terminal,
displaying an inquiry screen for inquiring data on the server;
transmitting a data inquiry request to the server in response to an inquiry instruction for inquiry data to be input on the inquiry screen; and
displaying, on the inquiry screen, an inquiry message indicating that data is being inquired, during a period of time from when the inquiry instruction is input until the inquiry data is received from the server.

12. The method according to claim 11, further comprising, in the mobile terminal, accepting an input for a transition to another screen while the inquiry message is being displayed.
